(19) United States
(12) Patent Application Publication
(10) Pub. No.: US 2019/0040818 A1
(43) Pub. Date: Feb. 7, 2019

(54) FUEL DELIVERY SYSTEM

(71) Applicant: Caterpillar Inc., Peoria, IL (US)

(72) Inventors: Matthew J. Engfehr, Dunlap, IL (US); Nathan P. Atterberry, Washington, IL (US)

(73) Assignee: Caterpillar Inc., Peoria, IL (US)

(21) Appl. No.: 15/670,006

(22) Filed: Aug. 7, 2017

(51) Int. Cl. F02M 21/02; F02D 41/00; F02D 41/14

(52) U.S. Cl. CPC F02M 21/0215; F02M 21/0293; F02M 21/0239; F02M 21/0242; F02D 41/0027; F02D 41/1477; F02M 21/0245

(57) ABSTRACT

A fuel delivery system for a machine powered by Liquified Natural Gas (LNG) fuel is provided. The fuel delivery system includes a pressure sensor provided in fluid communication with a fuel supply line, a first valve provided in in association with a high-pressure fuel rail circuit, a second valve provided in association with a low-pressure circuit, and a controller. The controller is configured to receive a signal indicative of a pressure of the LNG fuel present in the fuel supply line. The controller is also configured to compare the pressure of the LNG fuel with a predetermined pressure threshold. The controller is further configured to control at least one of the first valve and the second valve to selectively supply the LNG fuel to the high-pressure fuel rail circuit and the low-pressure circuit based, at least in part, on the comparison.

### TECHNICAL FIELD

The present disclosure relates to a fuel delivery system. More particularly, the present disclosure relates to the fuel delivery system for an engine associated with a machine.

### BACKGROUND

A machine powered by a Liquified Natural Gas (LNG) fueled engine includes one or more cryogenic LNG tanks onboard in order to store the LNG fuel therein. The LNG tank may be filled with the LNG fuel which may have a range of fuel characteristics, often referred to as a cold LNG fuel or a warm LNG fuel.

In a pumpless LNG fuel delivery system, a pressure of the LNG fuel available within the system is based on a temperature of the LNG fuel present in the LNG tank. In a fuel injection type of the fuel delivery system, such as a port injection type, a minimum amount of the pressure of the LNG fuel may be required within the system in order to overcome an intake manifold air pressure during an injection event. In many applications, the required minimum amount of the pressure of the LNG fuel within the system may be achieved by refueling the LNG tank with the warm LNG fuel.

However, in order to refuel the LNG tank with the warm LNG fuel, an operator may typically condition the LNG fuel prior to refueling the LNG tank from an LNG station. In a situation where the operator may refuel the LNG tank with cold LNG fuel, the pressure of the LNG fuel within the system may drop below the required minimum amount due to a bulk temperature of the cryogenic LNG fuel. As a result, the fuel delivery system may fail to operate and/or may result in damage to the system or components thereof. In such a situation, the LNG fuel may be purged from the LNG tank and the LNG tank may be refueled with the warm LNG fuel, in turn, leading to increased refueling time, increased machine idle time, reduced productivity, and so on.

Also, as the LNG fuel in the LNG tank may be consumed by the engine during an operation thereof, the pressure of the LNG fuel within the system may drop below the minimum amount. As a result, the fuel delivery system may fail to operate due to low fuel level or low pressure within the system. However, a residual LNG fuel may still be present in the LNG tank and/or within the system, in turn, reducing tank capacity, increasing fueling cycles, increasing machine idle time, and so on.

In such a situation, prior to or during refueling of the LNG tank, the operator may have to manually purge the residual LNG fuel out of the system and back to the LNG station in order to lower a vapor pressure within the LNG tank. As a result, the refueling process may require additional components, such as a purge line, valves, couplings, and so on, in turn, resulting in increased cost of the refueling process and refueling equipment, increased operator effort, and so on. Also, the purging of the residual LNG fuel may result in increased refueling time, increased machine idle time, reduced productivity, and so on. Hence, there is a need for an improved fuel delivery system for the engine powered by the LNG fuel.

U. S. Published Application Number 2015/0000643 describes a system for controlling bi-fuel operation of a locomotive power plant. The system includes an Electronic Control Unit (ECU) configured to control Liquid Natural Gas (LNG) fueling rates based on predetermined information associated with operation of the locomotive power plant. The system also includes a vaporization heating fluid system configured to control vaporization of the LNG delivered to the locomotive power plant. The vaporization heating fluid system is controlled by the ECU. The ECU receives power plant operating characteristic inputs for determining the rate of vaporization and control of vaporized LNG to the locomotive power plant. The system further includes a fuel measurement system configured to monitor and record real-time consumption of both diesel fuel and LNG.

### SUMMARY OF THE DISCLOSURE

In an aspect of the present disclosure, a fuel delivery system for a machine powered by Liquified Natural Gas (LNG) fuel is provided. The fuel delivery system includes a pressure sensor provided in fluid communication with a fuel supply line associated with the machine. The fuel delivery system includes a first valve provided in fluid communication with the fuel supply line and in association with a high-pressure fuel rail circuit. The fuel delivery system also includes a second valve provided in fluid communication with the fuel supply line and in association with a low-pressure circuit. The fuel delivery system further includes a controller provided in communication with the pressure sensor, the first valve, and the second valve. The controller is configured to receive a signal indicative of a pressure of the LNG fuel present in the fuel supply line. The controller is also configured to compare the pressure of the LNG fuel with a predetermined pressure threshold. The controller is further configured to control at least one of the first valve and the second valve to selectively supply the LNG fuel to the high-pressure fuel rail circuit and the low-pressure circuit based, at least in part, on the comparison.

In another aspect of the present disclosure, a fuel delivery system for an engine powered by Liquified Natural Gas (LNG) fuel is provided. The fuel delivery system includes a pressure sensor provided in fluid communication with a fuel supply line associated with the engine. The fuel delivery system includes a first valve provided in fluid communication with the fuel supply line and in association with a first fuel delivery circuit. The fuel delivery system also includes a second valve provided in fluid communication with the fuel supply line and in association with a second fuel delivery circuit. The fuel delivery system further includes a controller provided in communication with the pressure sensor, the first valve, and the second valve. The controller is configured to receive a signal indicative of a pressure of the LNG fuel present in the fuel supply line. The controller is also configured to compare the pressure of the LNG fuel with a predetermined pressure threshold. The controller is further configured to control at least one of the first valve and the second valve to selectively supply the LNG fuel to the engine through the first fuel delivery circuit based, at least in part, on the pressure of the LNG fuel exceeding the predetermined pressure threshold, and the second fuel delivery circuit based, at least in part, on the pressure of the LNG fuel dropping below the predetermined pressure threshold.

In yet another aspect of the present disclosure, a method for delivering Liquified Natural Gas (LNG) fuel to an engine of a machine is provided. The method includes receiving a signal indicative of a pressure of the LNG fuel present in a fuel supply line. The method also includes comparing the pressure of the LNG fuel with a predetermined pressure threshold. The method further includes controlling at least one of a first valve and a second valve to selectively supply the LNG fuel to the engine through a first fuel delivery circuit and a second fuel delivery circuit based, at least in part, on the comparison.

Other features and aspects of this disclosure will be apparent from the following description and the accompanying drawings.

### BRIEF DESCRIPTION OF THE DRAWINGS

FIG. 1 is a side view of an exemplary machine, according to an embodiment of the present disclosure;

FIG. 2 is a schematic representation of a fuel delivery system for the machine of FIG. 1, according to an embodiment of the present disclosure; and

FIG. 3 is a flowchart illustrating a method of working of the fuel delivery system of FIG. 2, according to an embodiment of the present disclosure.

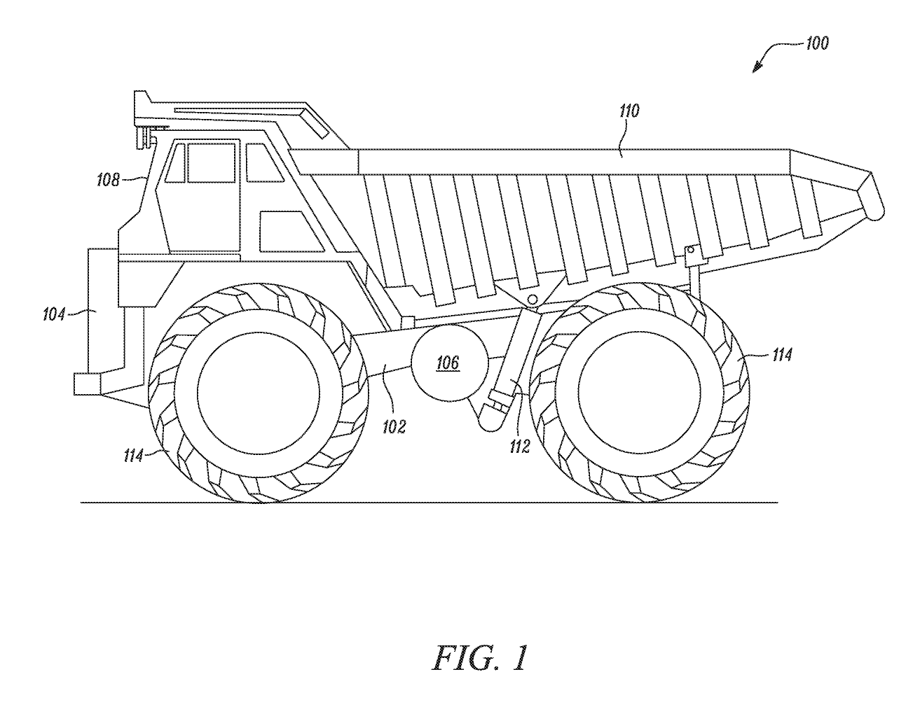

### DETAILED DESCRIPTION

Wherever possible, the same reference numbers will be used throughout the drawings to refer to the same or the like parts. Referring to FIG. 1, an exemplary machine 100 is illustrated. More specifically, the machine 100 is a mining truck. The machine 100 is adapted to transport material, such as ore, soil, rocks, and so on, from one location to another. In other embodiments, the machine 100 may be any other machine, such as an off-highway truck, an articulated truck, a haul truck, a dozer, a wheel loader, a locomotive, a marine vessel, and so on. The machine 100 may be any machine related to an industry including, but not limited to, agriculture, construction, transportation, mining, forestry, material handling, aviation, marine, and waste management.

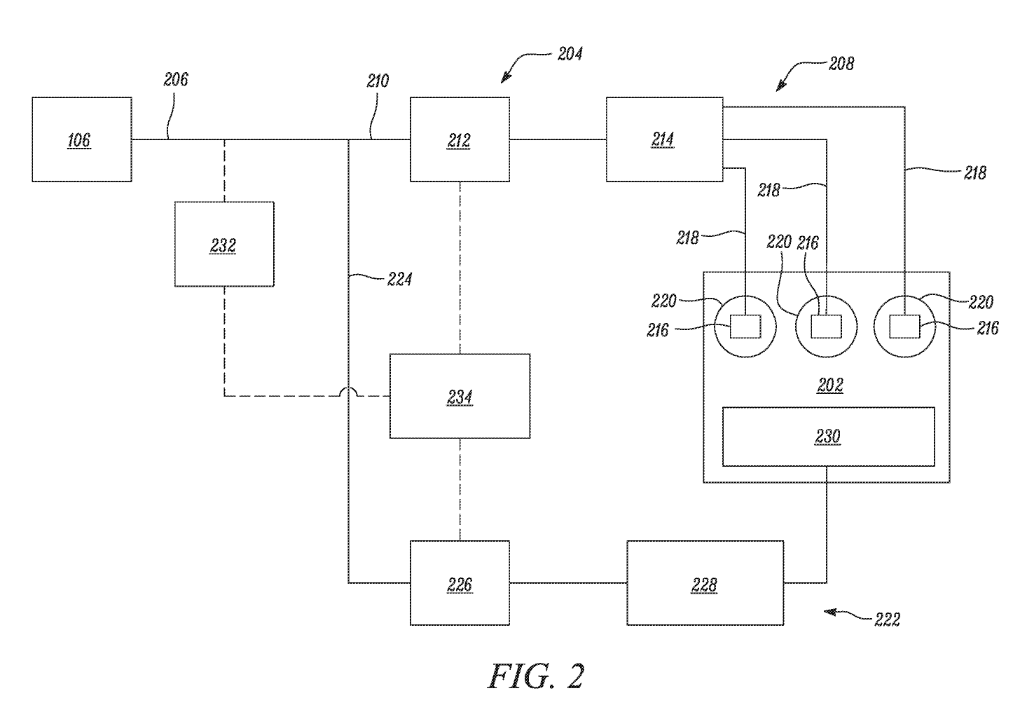

The machine 100 includes a frame 102. The frame 102 is adapted to support various components of the machine 100. The machine 100 includes an enclosure 104 mounted on the frame 102. The enclosure 104 is adapted to house an engine 202 (shown in FIG. 2) of the machine 100 therein. The engine 202 is adapted to provide power to the machine 100 for operational and mobility requirements. In the illustrated embodiment, the engine 202 is powered by a gaseous fuel, such as Liquified Natural Gas (LNG) fuel. Accordingly, the machine 100 includes an LNG tank 106 mounted on the frame 102 adapted to store the LNG fuel therein.

In other embodiments, the engine 202 may be a dual-fuel based engine powered by the LNG fuel and an additional fuel, such as diesel, gasoline, and so on. The enclosure 104 may also house various other components and systems (not shown) of the machine 100, such as a brake control system, a transmission system, a drive control system, a lubrication system, an engine control system, a cooling system, an air supply system, and so on.

The machine 100 includes an operator cabin 108 mounted on the frame 102. The operator cabin 108 is adapted to house one or more controls, such as a steering wheel, a pedal, a lever, a control console, buttons, knobs, an audio-visual system, an alarm system, and so on. The controls are adapted to operate and control the machine 100 on ground. The machine 100 includes a load bed 110 provided on the frame 102. The load bed 110 is adapted to load and unload material therefrom for transporting the material from one location to another.

The machine 100 also includes one or more hydraulic cylinders 112 coupled between the frame 102 and the load bed 110. The hydraulic cylinders 112 are adapted to tilt the load bed 110 during unloading of the material. The machine 100 also includes a set of wheels 114 mounted to the frame 102. The wheels 114 are adapted to support and provide mobility to the machine 100 on the ground.

Referring to FIG. 2, the machine 100 includes a fuel delivery system 204. The fuel delivery system 204 will be hereinafter interchangeably referred to as “the system 204”. The system 204 is adapted to supply the LNG fuel to the engine 202. The system 204 includes a main fuel supply line 206 fluidly coupled to the LNG tank 106. The main fuel supply line 206 will be hereinafter interchangeably referred to as “the main line 206”. The main line 206 is adapted to receive the LNG fuel from the LNG tank 106.

The system 204 includes a first fuel delivery circuit 208. The first fuel delivery circuit 208 will be hereinafter interchangeably referred to as “the first circuit 208”. The first circuit 208 is fluidly coupled to the main line 206 through a first fuel supply line 210. The first fuel supply line 210 will be hereinafter interchangeably referred to as “the first line 210”. In the illustrated embodiment, the first circuit 208 is a high-pressure fuel rail circuit.

Accordingly, the first circuit 208 includes a first valve 212 fluidly coupled to the first line 210 and downstream of the main line 206. The first valve 212 is adapted to control a flow of the LNG through the first line 210. In the illustrated embodiment, the first valve 212 is a throttle valve. In other embodiments, the first valve 212 may be an electromechanically operated purge valve. More specifically, the first valve 212 may be any other valve adapted to control a flow of a gaseous fluid therethrough, such as a pressure regulated valve, a solenoid operated valve, and so on.

The first circuit 208 also includes a fuel rail 214 fluidly coupled to the first line 210 and downstream of the first valve 212. The fuel rail 214 is adapted to store the LNG fuel therein under high pressure. The fuel rail 214 may be any high-pressure distribution chamber known in the art used for fuel systems. The first circuit 208 further includes one or more injectors 216 fluidly coupled to the fuel rail 214 through auxiliary first lines 218 respectively.

The injectors 216 are also fluidly coupled to one or more cylinders 220 of the engine 202 respectively. The injectors 216 are adapted to inject the LNG fuel at high pressure into the respective cylinders 220 of the engine 202 using any fuel injection method known in the art, such as port injection, direct injection, and so on. The injector 216 may be any fuel injector known in the art, such as a solenoid operated gas admission valve.

The system 204 includes a second fuel delivery circuit 222. The second fuel delivery circuit 222 will be hereinafter interchangeably referred to as “the second circuit 222”. The second circuit 222 is fluidly coupled to the main line 206 through a second fuel supply line 224. The second fuel supply line 224 will be hereinafter interchangeably referred to as “the second line 224”. In the illustrated embodiment, the second circuit 222 is a low-pressure circuit.

Accordingly, the second circuit 222 includes a second valve 226 fluidly coupled to the second line 224 and downstream of the main line 206. The second valve 226 is adapted to control a flow of the LNG fuel through the second line 224. In the illustrated embodiment, the second valve 226 is a shut-off valve. More specifically, the second valve 226 may be any other valve adapted to control a flow of a gaseous fluid therethrough, such as a pressure regulated valve, a solenoid operated valve, and so on.

The second circuit 222 also includes a compressor 228 fluidly coupled to the second line 224 and downstream of the second valve 226. The compressor 228 may be associated with a turbocharger (not shown) of the engine 202. The compressor 228 is adapted to receive the LNG fuel and air at low pressure in order to compress and pressurize a mixture the LNG fuel and air to a high pressure.

The compressor 228 may be any separate compressor unit or a compressor side of any turbocharger unit known in the art. The compressor 228 is further fluidly coupled to an intake manifold 230 of the engine 202. Accordingly, the intake manifold 230 is adapted to receive the pressurized mixture of the LNG fuel and air therein. The pressurized mixture of the LNG fuel and air is further supplied to the one or more cylinders 220 via the intake manifold 230.

The system 204 also includes a pressure sensor 232 fluidly coupled to the main line 206. The pressure sensor 232 is adapted to generate a signal indicative of a pressure of the LNG fuel present in the main line 206/the LNG tank 106. The pressure sensor 232 may be any pressure sensor known in the art, such as a strain gauge type pressure sensor, a capacitive type pressure sensor, an electromagnetic type pressure sensor, a piezoelectric type pressure sensor, an optical type pressure sensor, and so on.

The system 204 further includes a controller 234. The controller 234 may be any control unit known in the art configured to perform various machine functions. In one embodiment, the controller 234 may be a dedicated control unit configured to perform functions related to the system 204. In another embodiment, the controller 234 may be a Machine Control Unit (MCU) associated with the machine 100, an Engine Control Unit (ECU) associated with the engine 202, and so on. The controller 234 is communicably coupled to the pressure sensor 232, the first valve 212, and the second valve 226.

Accordingly, the controller 234 is configured to receive the signal indicative of the pressure of the LNG fuel within the main line 206/the LNG tank 106. The controller 234 is also configured to compare the pressure of the LNG fuel with a predetermined pressure threshold. The predetermined pressure threshold may be stored in an internal memory (not shown) of the controller 234 or a database (not shown) communicably coupled to the controller 234.

In one embodiment, the predetermined pressure threshold may be a single pressure threshold value. In another embodiment, the controller 234 may determine the predetermined pressure threshold based on a dataset (not shown). The dataset may be stored in the database or the internal memory of the controller 234. The dataset may include various values of the predetermined pressure threshold based on varying values of one or more operating parameters, such as an engine speed, an engine load, a level of the LNG fuel within the LNG tank 106, a temperature of the LNG fuel within the LNG tank 106, and so on. In yet another embodiment, the controller 234 may determine the predetermined pressure threshold based on a correlation stored in the database or the internal memory of the controller 234. The correlation may include a mathematical expression between the predetermined pressure threshold and the one or more operating parameters.

Based on the comparison, the controller 234 is further configured to control at least one of the first valve 212 and the second valve 226 to selectively supply the LNG fuel to the first circuit 208 and the second circuit 222. For example, in a situation, when the pressure of the LNG fuel equals or exceeds the predetermined pressure threshold, the controller 234 opens the first valve 212 and closes the second valve 226 in order to selectively supply the LNG fuel to the engine 202 through the first circuit 208 and limit the supply of the LNG fuel to the engine 202 through the second circuit 222. In another situation, when the pressure of the LNG fuel drops below the predetermined pressure threshold, the controller 234 closes the first valve 212 and opens the second valve 226 in order to selectively supply the LNG fuel to the engine 202 through the second circuit 222 and limit the supply of the LNG fuel to the engine 202 through the first circuit 208.

### INDUSTRIAL APPLICABILITY

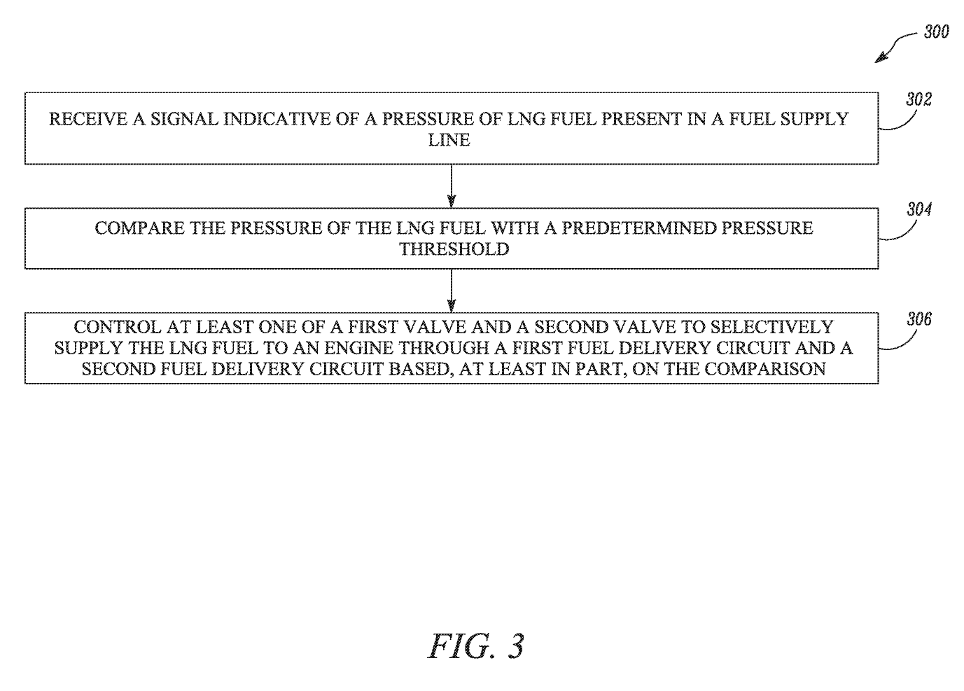

The present disclosure relates to a method 300 of working of the fuel delivery system 204. Referring to FIG. 3, a flowchart of the method 300 is illustrated. At step 302, the controller 234 receives the signal indicative of the pressure of the LNG fuel present in the main line 206/the LNG tank 106 from the pressure sensor 232. At step 304, the controller 234 compares the pressure of the LNG fuel with the predetermined pressure threshold.

At step 306, based on the comparison, the controller 234 controls at least one of the first valve 212 and the second valve 226 to selectively supply the LNG fuel to the engine 202 through the first fuel delivery circuit 208 and the second fuel delivery circuit 222. In the illustrated embodiment, the first valve 212 is the throttle valve, and the second valve 226 is the shut-off valve. In other embodiments, the first valve 212 may be the electromechanically operated purge valve. Also, in the illustrated embodiment, the first fuel delivery circuit 208 is the high-pressure fuel rail circuit, and the second fuel delivery circuit 222 is the low-pressure circuit.

More specifically, in one situation, when the pressure of the LNG fuel within the main line 206/the LNG tank 106 equals or exceeds the predetermined pressure threshold, the controller 234 opens the first valve 212 and closes the second valve 226 in order to selectively supply the LNG fuel to the engine 202 through the first circuit 208 and limit the supply of the LNG fuel to the engine 202 through the second circuit 222. In another situation, when the pressure of the LNG fuel within the main line 206/the LNG tank 106 drops below the predetermined pressure threshold, the controller 234 closes the first valve 212 and opens the second valve 226 in order to selectively supply the LNG fuel to the engine 202 through the second circuit 222 and limit the supply of the LNG fuel to the engine 202 through the first circuit 208.

The system 204 provides a simple, efficient, and cost-effective method of switching between the first fuel delivery circuit 208 and the second fuel delivery circuit 222 without employing complex circuitry, electronics, and/or components. For example, in a situation when the LNG tank 106 may be refueled with the LNG fuel having cold characteristics, the system 204 may switch to the second circuit 222, viz. the low-pressure circuit, based on the pressure of the LNG fuel within the LNG tank 106 dropping below the predetermined pressure threshold.

As a result, the system 204 may limit dependence on an operator for refueling the LNG tank 106 with warm or conditioned LNG fuel. The system 204 may also limit defueling the LNG tank 106 of the LNG fuel having cold characteristics and again refueling the LNG tank 106 with the LNG fuel having warm characteristics, in turn, limiting operator error, reducing refueling time, reducing machine idle time, improving machine utilization and productivity, and so on.

In another situation when the LNG tank 106 may be refueled with the LNG fuel having warm characteristics and/or the pressure within the LNG tank 106 may be equal to or higher than the predetermined pressure threshold, the system 204 may switch to the first circuit 208, viz. the high-pressure fuel rail circuit, based on the pressure of the LNG fuel within the LNG tank 106 exceeding the predetermined pressure threshold.

In yet another situation, as the level of the LNG fuel within the LNG tank 106 may drop due to operation of the engine 202, the pressure within the LNG tank 106 may drop below the predetermined pressure threshold. Accordingly, the system 204 may switch to the second circuit 222, viz. the low-pressure circuit. As a result, the system 204 may provide complete utilization of the residual LNG fuel present in the LNG tank 106.

As such, the system 204 may provide longer duration between successive refueling intervals due to complete utilization of the residual LNG fuel. Also, the system 204 may provide to limit purging of the LNG tank 106 during refueling, in turn, limiting use of an additional vent line and venting process. Additionally, the system 204 may provide to reduce refueling time due to complete utilization of the residual LNG fuel and lower vapor pressure therein.

The system 204 may employ components known in the art and/or already existing on the machine 100, such as the pressure sensor 232, the first valve 212, the second valve 226, the controller 234, and so on. As such, the system 204 may provide to reduce capital cost, development cost, and so on. Also, the system 204 may be retrofitted on any engine/machine with little or no modification to the existing system 204.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

1. A fuel delivery system for a machine powered by Liquified Natural Gas (LNG) fuel, the fuel delivery system comprising:
a pressure sensor provided in fluid communication with a main fuel supply line associated with the machine to determine pressure of the LNG fuel in the main fuel supply line;
a high-pressure fuel rail circuit, at an output of the main fuel supply line, that supplies the LNG fuel to fuel injectors of the machine for injection into respective cylinders of an engine of the machine, wherein the high-pressure fuel rail circuit includes a first fuel supply line at the output of the main fuel supply line, and a first valve in the first fuel supply line;
a low-pressure circuit, at the output of the main fuel supply line, that supplies the LNG fuel at a low pressure, the low pressure LNG fuel is pressurized and supplied via an intake manifold to at least one of the cylinders of the engine, wherein the low pressure circuit includes a second fuel supply line, distinct from the first fuel supply line, at the output of the main fuel supply line, and a second valve in the second fuel supply line; and
a controller provided in communication with the pressure sensor, the first valve, and the second valve, the controller configured to:
receive a signal indicative of the pressure of the LNG fuel present in the fuel supply line;
compare the pressure of the LNG fuel in the main fuel supply line with a predetermined pressure threshold; and
control at least one of the first valve and the second valve to selectively supply the LNG fuel to the high-pressure fuel rail circuit and the low-pressure circuit based, at least in part, on the comparison,
wherein the LNG fuel is supplied to the engine via the high-pressure fuel rail circuit for injection when the comparison is such that the pressure of the LNG fuel in the main fuel supply line exceeds the predetermined pressure threshold, and
wherein the LNG fuel is supplied to the engine via the low-pressure circuit and without injection when the comparison is such that the pressure of the LNG fuel in the main fuel supply line does not exceed the predetermined pressure threshold.

2. The fuel delivery system of claim 1, wherein controlling at least one of the first valve and the second valve further includes opening the first valve and closing the second valve based, at least in part, on the pressure of the LNG fuel exceeding the predetermined pressure threshold.

3. The fuel delivery system of claim 1, wherein controlling at least one of the first valve and the second valve further includes closing the first valve and opening the second valve based, at least in part, on the pressure of the LNG fuel dropping below the predetermined pressure threshold.

4. The fuel delivery system of claim 1, wherein the first valve is a throttle valve.

5. The fuel delivery system of claim 1, wherein the first valve is an electromechanically operated purge valve.

6. The fuel delivery system of claim 1, wherein the second valve is a shut-off valve.

7. A fuel delivery system for an engine powered by Liquified Natural Gas (LNG) fuel, the fuel delivery system comprising:
a pressure sensor provided in fluid communication with a main fuel supply line associated with the engine to determine pressure of the LNG fuel in the main fuel supply line;
a first fuel delivery circuit, at an output of the main fuel supply line, that supplies the LNG fuel to fuel injectors of the engine for injection into respective cylinders of the engine, wherein the first fuel delivery circuit includes a first fuel supply line at the output of the main fuel supply line, and a first valve in the first fuel supply line;
a second fuel delivery circuit, at the output of the main fuel supply line, that supplies the LNG fuel at a low pressure, the low pressure LNG fuel is pressurized and supplied via an intake manifold to at least one of the cylinders of the engine, wherein the second fuel delivery circuit includes a second fuel supply line, distinct from the first fuel supply line, at the output of the main fuel supply line, and a second valve in the second fuel supply line; and
a controller provided in communication with the pressure sensor, the first valve, and the second valve, the controller configured to:
receive a signal indicative of the pressure of the LNG fuel present in the fuel supply line;
compare the pressure of the LNG fuel in the main fuel supply line with a predetermined pressure threshold; and
control at least one of the first valve and the second valve to selectively supply the LNG fuel to the engine through the first fuel delivery circuit based, at least in part, on the pressure of the LNG fuel exceeding the predetermined pressure threshold, and the second fuel delivery circuit based, at least in part, on the pressure of the LNG fuel dropping below the predetermined pressure threshold,
wherein the LNG fuel is supplied to the engine via the first fuel delivery circuit for injection when the comparison is such that the pressure of the LNG fuel in the main fuel supply line exceeds the predetermined pressure threshold, and
wherein the LNG fuel is supplied to the engine via the second fuel delivery circuit and without injection when the comparison is such that the pressure of the LNG fuel in the main fuel supply line does not exceed the predetermined pressure threshold.

8. The fuel delivery system of claim 7, wherein the first fuel delivery circuit is a high-pressure fuel rail circuit.

9. The fuel delivery system of claim 7, wherein the second fuel delivery circuit is a low-pressure circuit.

10. The fuel delivery system of claim 7, wherein the first valve is a throttle valve.

11. The fuel delivery system of claim 7, wherein the first valve is an electromechanically operated purge valve.

12. The fuel delivery system of claim 7, wherein the second valve is a shut-off valve.

13. A method for delivering Liquified Natural Gas (LNG) fuel to an engine of a machine, the method comprising:
receiving a signal indicative of a pressure of the LNG fuel present in a main fuel supply line;
comparing the pressure of the LNG fuel in the main fuel supply line with a predetermined pressure threshold; and
controlling at least one of a first valve and a second valve to selectively supply the LNG fuel to the engine through a first fuel delivery circuit and a second fuel delivery circuit based, at least in part, on the comparison,
wherein the first fuel delivery circuit is at an output of the main fuel supply line and supplies the LNG fuel to fuel injectors of the engine for injection into respective cylinders of the engine, wherein the first fuel delivery circuit includes a first fuel supply line at the output of the main fuel supply line, and the first valve in the first fuel supply line,
wherein the second fuel delivery circuit is at the output of the main fuel supply line, supplies the LNG fuel at a low pressure, the low pressure LNG fuel is pressurized and supplied via an intake manifold to at least one of the cylinders of the engine, wherein the second fuel delivery circuit includes the second fuel supply line, distinct from the first fuel supply line, at the output of the main fuel supply line, and the second valve in the second fuel supply line,
wherein the LNG fuel is supplied to the engine via the first fuel delivery circuit when the comparison is such that the pressure of the LNG fuel in the main fuel supply line exceeds the predetermined pressure threshold, and
wherein the LNG fuel is supplied to the engine via the second fuel delivery circuit when the comparison is such that the pressure of the LNG fuel in the main fuel supply line does not exceed the predetermined pressure threshold.

14. The method of claim 13, wherein controlling at least one of the first valve and the second valve further includes opening the first valve and closing the second valve to supply the LNG fuel through the first fuel delivery circuit based, at least in part, on the pressure of the LNG fuel exceeding the predetermined pressure threshold.

15. The method of claim 13, wherein controlling at least one of the first valve and the second valve further includes closing the first valve and opening the second valve to supply the LNG fuel through the second fuel delivery circuit based, at least in part, on the pressure of the LNG fuel dropping below the predetermined pressure threshold.

16. The method of claim 13, wherein the first fuel delivery circuit is a high-pressure fuel rail circuit.

17. The method of claim 13, wherein the second fuel delivery circuit is a low-pressure circuit.

18. The method of claim 13, wherein the first valve is a throttle valve.

19. The method of claim 13, wherein the first valve is an electromechanically operated purge valve.

20. The method of claim 13, wherein the second valve is a shut-off valve.
